(19) United States
(12) Patent Application Publication
(10) Pub. No.: US 2026/0246101 A1
(43) Pub. Date: Aug. 20, 2026

(54) SECONDARY BATTERY MODULE, FILM-TYPE CELL CONTROL UNIT FOR SECONDARY BATTERY MODULE, AND METHOD OF MANUFACTURING SECONDARY BATTERY MODULE

(71) Applicant: Samsung SDI Co., Ltd., Yongin-si (KR)

(72) Inventor: YUsik Hwang, Yongin-si (KR)

(21) Appl. No.: 19/409,585

(22) Filed: Dec. 4, 2025

(30) Foreign Application Priority Data
Feb. 17, 2025 (KR) 10-2025-0020388

(51) Int. Cl. H01M 50/519; H01M 10/04; H01M 10/42; H01M 50/242; H01M 50/507; H01M 50/204; H01M 50/249

(52) U.S. Cl. CPC H01M 50/519; H01M 10/04; H01M 10/4257; H01M 50/242; H01M 50/507; H01M 2010/4271; H01M 50/204; H01M 50/249

(57) ABSTRACT

A secondary battery module includes a plurality of battery cells each of which has a positive electrode terminal and a negative electrode terminal, a cell control unit configured to control the battery cells, and a module case configured to accommodate the battery cells and the cell control unit, wherein the cell control unit includes: a base film, bus bars on the base film and connected to the positive electrode terminal and the negative electrode terminal, and a flexible printed circuit board (FPCB) connected to the bus bars and fixed to the base film.

### CROSS-REFERENCE TO RELATED APPLICATION

The present application claims priority to and the benefit of Korean Patent Application No. 10-2025-0020388, filed on February 17, 2025, in the Korean Intellectual Property Office, the entire disclosure of which is incorporated herein by reference.

### BACKGROUND

### Field

Aspects of the present disclosure relate to a secondary battery module.

### Description of the Related Art

Secondary batteries are batteries that can be charged and discharged, unlike primary batteries that cannot be recharged. In general, a secondary battery includes an electrode assembly formed of electrode plates of positive and negative electrodes, a case that accommodates the electrode assembly, an electrode terminal connected to the electrode assembly, a vent for degassing gas generated inside the case, and the like. Recently, secondary batteries are being used for motor driving and power storage in hybrid vehicles, electric vehicles, etc., and are becoming larger in capacity.

A cell control unit (CCU) embedded in a secondary battery module is located between a cell and a battery management system (BMS) of the module. Because CCUs of the related art are manufactured by molding with plastic, they have a certain thickness and weight and thus have a disadvantage of limiting the design of the module. A height of the secondary battery module is increased by the CCU. As a thickness of the CCU increases, the space efficiency of the module inevitably decreases. There is a need for technology that can make the size of a secondary battery module more compactly by reducing the thickness of the CCU.

The above information disclosed in this Background section is for enhancement of understanding of the background of the present disclosure, and therefore, it may contain information that does not constitute a related art.

### SUMMARY

Aspects of embodiments of the present disclosure are directed to providing a secondary battery module, a film-type cell control unit for a secondary battery module, and a method of manufacturing a secondary battery module, in which a film-type cell control unit (CCU) having a relatively small thickness compared to a CCU of the related art formed of plastic is provided, it is possible to achieve excellent space efficiency of the module and increase a volume rate and capacity.

According to some embodiments of the present disclosure, there is provided a secondary battery module including: a plurality of battery cells each of which has a positive electrode terminal and a negative electrode terminal; a cell control unit configured to control the battery cells; and a module case configured to accommodate the battery cells and the cell control unit, wherein the cell control unit includes: a base film; bus bars on the base film and connected to the positive electrode terminal and the negative electrode terminal; and a flexible printed circuit board (FPCB) connected to the bus bars and fixed to the base film.

In some embodiments, the base film has a stacked structure including a core layer and cover layers covering an upper surface and a bottom surface of the core layer.

In some embodiments, the core layer is a cycloolefin copolymer (COC) film.

In some embodiments, each of the cover layers is a film formed of a polymer material.

In some embodiments, the base film further includes an insulator covering a part of the bus bars and is mounted on a cover layer of the cover layers of the base film.

In some embodiments, the core layer includes inorganic nanoparticles.

In some embodiments, the cover layers include inorganic nanoparticles.

In some embodiments, the base film includes a support protrusion formed on a bottom surface of the base film, and the support protrusion is inserted between neighboring battery cells to suppress relative movement of the base film with respect to the battery cells.

In some embodiments, the base film includes a reinforcing layer formed to reinforce a structure of the base film and is provided between the core layer and a cover layer of the cover layers.

According to some embodiments of the present disclosure, there is provided a film-type cell control unit for a secondary battery module, including: a base film configured to provide a support force to a plurality of battery cells each of which has a positive electrode terminal and a negative electrode terminal; bus bars on the base film and connected to the positive electrode terminal and the negative electrode terminal; and a flexible printed circuit board (FPCB) connected to the bus bars and fixed to an upper surface of the base film.

In some embodiments, the base film has a stacked structure including a core layer and cover layers covering an upper surface and a bottom surface of the core layer.

In some embodiments, the core layer is a cycloolefin copolymer (COC) film.

In some embodiments, each of the cover layers is a film formed of a polymer material.

In some embodiments, the base film further includes an insulator covering a part of the bus bars and is mounted on a cover layer of the cover layer of the base film.

In some embodiments, the core layer includes inorganic nanoparticles.

In some embodiments, the cover layers include inorganic nanoparticles.

In some embodiments, the base film includes a support protrusion formed on a bottom surface of the base film, and the support protrusion is inserted between neighboring battery cells to suppress relative movement of the base film with respect to the battery cells.

In some embodiments, the base film includes a reinforcing layer formed to reinforce a structure of the base film and is provided between the core layer and a cover layer of the cover layers.

According to some embodiments of the present disclosure, there is provided a method of manufacturing a secondary battery module, including: a battery cell mounting operation of mounting a plurality of battery cells each having a positive electrode terminal and a negative electrode terminal in a case main body; a base film fixing operation of fixing a base film to the battery cell; a bus bar installing operation of arranging bus bars on the base film and connecting the bus bars to the positive electrode terminal and the negative electrode terminal; a flexible printed circuit board (FPCB) fixing operation of fixing an FPCB to the base film and connecting the FPCB to the bus bars; and a top plate mounting operation of covering the case main body with a top plate to seal the case main body.

In some embodiments, the base film fixing operation is a process of adhering the base film to the battery cells, and the FPCB fixing operation is a process of adhesively coupling the FPCB to an upper surface of the base film.

Aspects and features of the present disclosure are not limited to those described above, and other aspects and features not specifically mentioned herein will be clearly understood by those skilled in the art from the description of the present disclosure below.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a perspective view of a battery cell applied to a secondary battery module according to some embodiments of the present disclosure;

FIG. 2 is a cross-sectional view along the line A-A in FIG. 1, according to some embodiments of the present disclosure.

FIG. 3 is a cutaway plan view of the secondary battery module according to some embodiments of the present disclosure;

FIG. 4 is a view illustrating a secondary battery pack in which the secondary battery module is embedded, according to some embodiments of the present disclosure;

FIG. 5 is a view illustrating a vehicle to which the secondary battery pack of FIG. 4 is applied, according to some embodiments of the present disclosure;

FIG. 6 is a view for describing a basic structure of a cell control unit for a secondary battery module according to some embodiments of the present disclosure;

FIG. 7 is a perspective view separately illustrating a base film of FIG. 6, according to some embodiments of the present disclosure;

FIG. 8 is a view illustrating a stacked structure of the base film illustrated in FIG. 7, according to some embodiments of the present disclosure;

FIGS. 9 to 12 are cross-sectional views for describing various stack examples of the base film illustrated in FIG. 7, according to some embodiments of the present disclosure;

FIG. 13 is a cross-sectional view illustrating still another example of the base film according to some embodiments of the present disclosure;

FIG. 14 is a flowchart illustrating a method of manufacturing a secondary battery module according to some embodiments of the present disclosure; and

FIGS. 15A-15E are schematic views illustrating a method of manufacturing a secondary battery module according to some embodiments of the present disclosure.

### DETAILED DESCRIPTION

Hereinafter, embodiments of the present disclosure will be described, in detail, with reference to the accompanying drawings. The terms or words used in the present specification and claims are not to be narrowly interpreted according to their general or dictionary meanings and should be interpreted as having meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some embodiments of the present disclosure and do not represent all of the aspects, features, and embodiments of the present disclosure. Accordingly, it should be understood that there may be various equivalents and modifications that can replace or modify one or more embodiments or features therein described herein at the time of filing this application.

It will be understood that if an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same.” Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

Throughout the specification, unless otherwise stated, each element may be provided in singular or plural form.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.”

Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to limit the present disclosure.

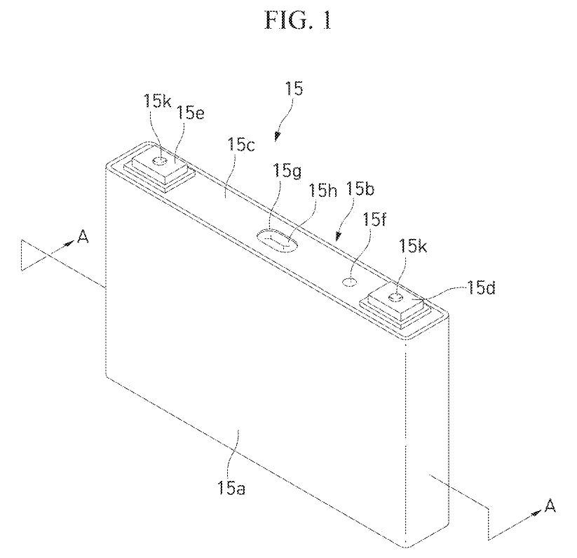

FIG. 1 is a perspective view of a battery cell applied to a secondary battery module according to some embodiments of the present disclosure.

A case 15a forms the overall appearance of a prismatic battery and may be formed of a conductive metal such as aluminum, an aluminum alloy, or nickel-plated steel. In addition, the case 15a may provide a space for accommodating an electrode assembly therein.

A cap assembly 15b may include a cap plate 15c that covers the opening of the case 15a. In some examples, the case 15a and the cap plate 15c may be made of a conductive material. Here, a positive electrode terminal 15d and a negative electrode terminal 15e may be electrically connected to respective positive and negative electrodes inside the case and may be installed to protrude outward from the cap plate 15c.

An electrolyte injection port 15f may be formed in the cap plate 15c, a vent hole 15g may be opened, and a vent part 15h may be joined to the vent hole 15g. The vent part 15h is opened by gas generated inside the battery and is thus capable of performing a degassing function.

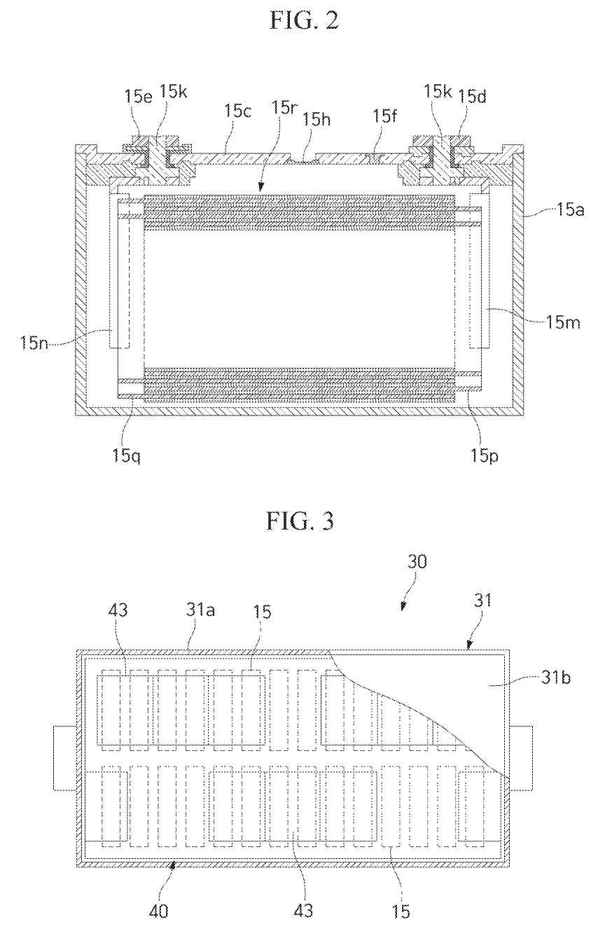

FIG. 2 is a cross-sectional view along the line A-A in FIG. 1, according to some embodiments of the present disclosure.

The electrode assembly 13a may be formed by winding or stacking a first electrode plate, a separator, and a second electrode plate formed in a plate shape or film shape. When the electrode assembly 15r is a wound stack, a winding axis may be parallel to the longitudinal direction of the case. In some other embodiments, the electrode assembly 15r is a stack type rather than a winding type. However, the shape of the electrode assembly 15r is not limited thereto, and any suitable structure may be utilized.

For example, the electrode assembly 15r may be a Z-stack electrode assembly in which a positive electrode plate and a negative electrode plate are inserted into both sides of a separator, which is then bent into a Z-stack. In addition, one or more electrode assemblies 15r may be stacked such that long sides of the electrode assemblies are adjacent to each other and accommodated in the case, and the number of electrode assemblies in the case is not limited in the present disclosure. In some examples, the first electrode plate of the electrode assembly 15r may act as a negative electrode, and the second electrode plate may act as a positive electrode. In other examples, the first electrode plate of the electrode assembly 15r may act as a positive electrode, and the second electrode plate may act as a negative electrode.

The first electrode plate may be formed by applying a first electrode active material, such as graphite, carbon, or the like, to a first electrode current collector formed of a metal foil, such as copper, a copper alloy, nickel, a nickel alloy, or the like. The first electrode plate may include a first electrode tab 15p (e.g., a first uncoated portion) that is a region to which the first electrode active material is not applied. The first electrode tab 15p may act as a current flow path between the first electrode plate and the first current collector 15m. In some embodiments, when the first electrode plate is manufactured, the first electrode tab 15p is formed by being cut in advance to protrude to one side of the electrode assembly, or the first electrode tab protrudes from one side of the electrode assembly more than (e.g., farther than or beyond) the separator without being separately cut.

The second electrode plate may be formed by applying a second electrode active material, such as a transition metal oxide, on a second electrode current collector formed of a metal foil, such as aluminum or an aluminum alloy. The second electrode plate may include a second electrode tab 15q (e.g., a second uncoated portion) that is a region to which the second electrode active material is not applied. The second electrode tab 15q may act as a current flow path between the second electrode plate and the second current collector 15n. In some embodiments, the second electrode tab 15q may be formed by being cut in advance to protrude from the other side (e.g., the opposite side) of the electrode assembly when the second electrode plate is manufactured, or the second electrode plate may protrude from the other side of the electrode assembly more than (e.g., farther than or beyond) the separator without being separately cut.

In FIG. 2, the first electrode tab 15p and the second electrode tab 15q are illustrated as being positioned on the right side and the left side of the electrode assembly 15r, respectively. However, in some embodiments, both the first electrode tab 15p and the second electrode tab 15q may be positioned together on the right side or the left side of the electrode assembly 15r.

Here, the left side and the right side of the electrode assembly 15r are based on the battery illustrated in FIG. 5 for convenience of explanation. The left side refers to the side of the vertical surface of the electrode assembly 15r to which the second current collector 15n is joined, and the right side refers to the opposite side, to which the first current collector plate is joined. Therefore, the terms “left side” and “right side” of the electrode assembly 15r used herein may refer to different parts of the battery as the orientation of the battery changes (e.g., when the battery rotates left and right or up and down).

The separator prevents or substantially reduces instances of a short circuit between the first electrode and the second electrode while allowing movement of lithium ions therebetween. The separator may be made of, for example, a polyethylene film, a polypropylene film, a polyethylene-polypropylene film, or the like.

In some embodiments, an electrode assembly 15r is accommodated in the case 15a along with an electrolyte.

In the electrode assembly 15r, the first current collector 15m and the second current collector 15n may be welded and connected to the first electrode tab 15p extending from the first electrode plate and the second electrode tab 15q extending from the second electrode plate, respectively.

The first current collector 15m and the second current collector 15n are electrically connected to the positive electrode terminal 15d and the negative electrode terminal 15e described in FIG. 1, respectively, through connection members 15k. In some embodiments, the connection members 15k may each have an outer peripheral surface that is threaded and may be fastened to the positive electrode terminal 15d and the negative electrode terminal 15e by screwing. However, the present disclosure is not limited thereto. For example, the connection members 15k may also be coupled to the positive electrode terminal 15d and the negative electrode terminal 15e by riveting, welding, or any other suitable mechanism.

FIG. 3 is a cutaway plan view of a secondary battery module 30 according to some embodiments of the present disclosure.

As shown, the secondary battery module 30 according to some embodiments may include a module case 31, a plurality of battery cells 15, and a film-type cell control unit (CCU) 40.

The module case 31 may include a case main body 31a and a top plate 31b. The case main body 31a opens upward and provides a space that may accommodate a battery cell 15. In addition, the top plate 31b may be coupled to an upper portion of the case main body 31a to seal the space of the case main body 31a. The top plate 31b may be opened to perform maintenance for components inside the case main body 31a.

The battery cell 15 may have a structure illustrated in FIG. 1 and is embedded in the module case 31. As described through FIG. 1, a vent part 15h may be located at an upper central portion of the battery cell 15, and the positive electrode terminal 15d and the negative electrode terminal 15e may be disposed at the left and right of the vent part 15h, respectively. A plurality of battery cells 15 have the same capacity and size and may be arranged parallel to each other in two rows. An arrangement structure of the battery cells 15 may vary in different examples. In addition, a spacer (or gap) may be interposed (e.g., located) between the battery cells 15.

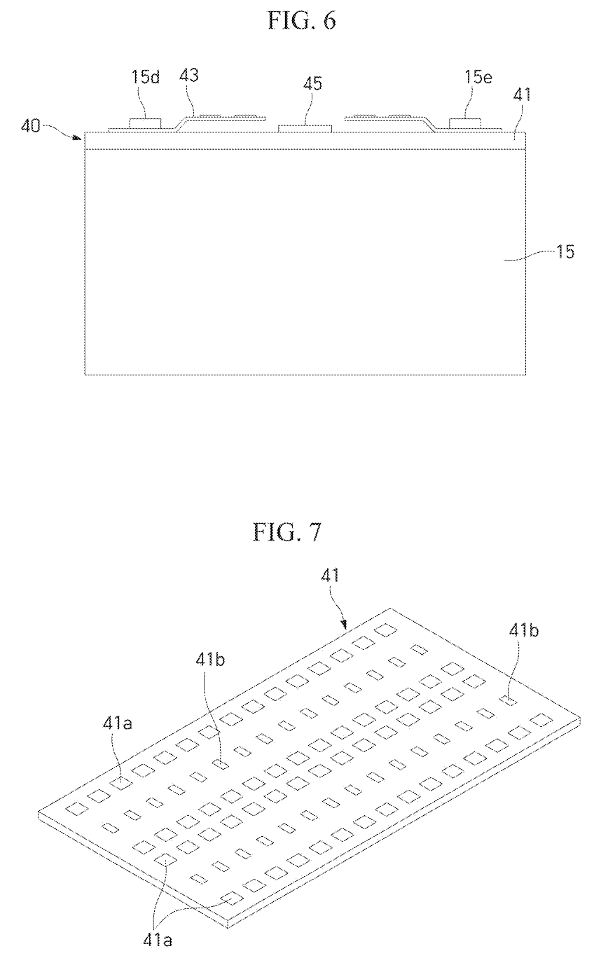

The film-type cell control unit 40 is a film-type element fixed to an upper portion of the battery cell 15 and may be connected to each battery cell to control the battery cell. A plurality of bus bars 43 and a flexible printed circuit board (FPCB) 45 (see, e.g., FIG. 6) may be fixed to an upper surface of the cell control unit 40. The cell control unit 40 will be described in further detail below.

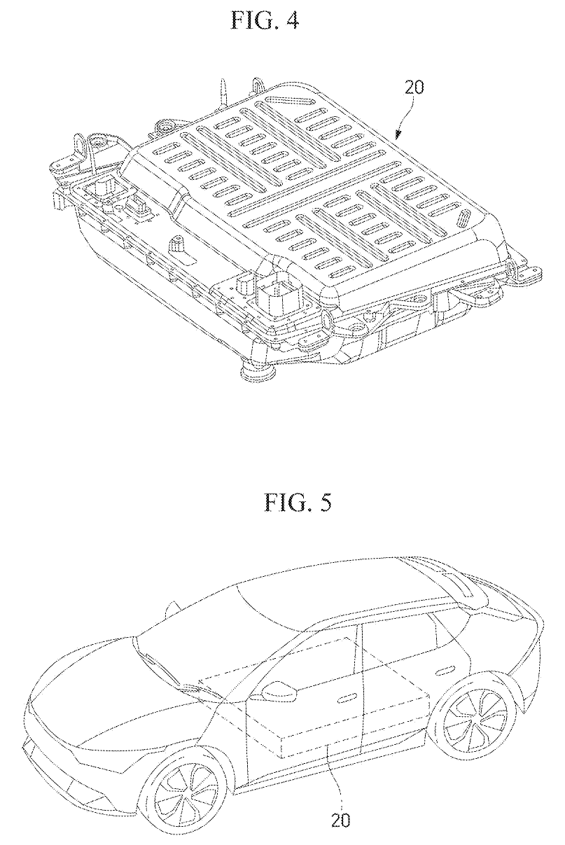

FIG. 4 is a view illustrating a secondary battery pack 20 in which the secondary battery module 30 is embedded, according to some embodiments of the present disclosure. The secondary battery pack 20 may be manufactured by allowing a plurality of secondary battery modules to be embedded in a pack housing having a form designed to be mounted on an actual product. The pack housing may include fasteners and electrical outlets that are utilized for product mounting. In FIG. 4, for convenience of illustration, components such as a bus bar, a cooling unit, external terminals for electrically connecting secondary batteries, etc., are not illustrated. The secondary battery pack may be mounted on a vehicle. The vehicle may be, for example, an electric vehicle, a hybrid vehicle, or a plug-in hybrid vehicle. The vehicle may be a four-wheel drive vehicle or a two-wheel drive vehicle.

FIG. 5 is a view illustrating a vehicle to which the secondary battery pack of FIG. 4 is applied, according to some embodiments of the present disclosure. FIG. 5 illustrates the secondary battery pack 20 according to some embodiments of the present disclosure, which is mounted on an underbody of a vehicle. The vehicle is operated by receiving power from the secondary battery pack 20 according to some embodiments of the present disclosure.

FIG. 6 is a view for describing a basic structure of the cell control unit 40 for a secondary battery module according to some embodiments of the present disclosure. FIG. 6 illustrates a front view of the battery cell 15.

As illustrated, the cell control unit 40 according to some embodiments may include a base film 41, the bus bar 43, and the FPCB 45. The cell control unit 40 may monitor and control the state of the battery cell 15. For example, the cell control unit 40 may detect a voltage and temperature of the battery cell in real time to prevent or substantially reduces instances of overcharging or overheating and adjust a voltage difference between the battery cells to maintain uniform performance. In addition, the cell control unit 40 may transmit the state of the secondary battery module 30 to an upper-level system through an external battery management system (BMS) to support efficient and stable operation of the secondary battery module.

The base film 41 is a member having a set or predetermined thickness and adhesively fixed to the upper portion of the battery cell. The base film 41 may be flexible. FIG. 7 schematically illustrates the base film 41.

As described above, the cell control unit 40 may include the base film 41, the bus bar 43, the FPCB 45, etc. and serve to monitor and control the state of the battery cell 15 in real time. For example, the cell control unit 40 may continuously detect the voltage and temperature of the battery cell 15 to prevent or substantially reduces instances of overcharging or overheating. Through such a detection function, the voltage difference between the battery cells may be adjusted to maintain uniform performance. In addition, the cell control unit 40 may transmit the state information of the secondary battery module 30 to the upper-level system in conjunction with the external BMS to support the efficient and stable operation of the entire system.

The base film 41 is a member that has a set or predetermined thickness and is adhesively fixed to the upper portion of the battery cell and can be easily applied to various types of battery cells 15 due to flexibility. Because the base film 41 is flexible in this way, the base film 41 can perform a stable operation without damage, such as breaking, etc., even when an impact is transferred from the outside.

As illustrated in FIG. 7, the base film 41 may be a quadrangular member having a set or predetermined thickness and may have a plurality of terminal passages 41a and vent hole corresponding holes 41b. The terminal passage 41a is a hole that allows the positive electrode terminal 15d and the negative electrode terminal 15e of the battery cell 15 to pass therethrough. In addition, the vent hole corresponding hole 41b is a hole that opens the vent hole 15g upward. The sizes or interval of the terminal passage 41a and the vent hole corresponding hole 41b may vary according to the interval or shape of the battery cells 15 disposed in the module case 31. In particular, as will be described in further detail below, the base film 41 has a stacked structure including a core layer and a cover layer.

The base film 41 may be adhesively fixed to the upper surface of the battery cell 15. In such examples, the positive electrode terminal 15d and the negative electrode terminal 15e of the battery cell 15 may pass through the terminal passage 41a of the base film 41. The positive electrode terminal 15d and the negative electrode terminal 15e may be welded to the bus bar 43 while being exposed upward through the base film 41. Because the base film 41 is thin, the positive electrode terminal 15d and the negative electrode terminal 15e may pass through the base film 41 and protrude further (e.g., higher) than the base film 41.

The bus bar 43 may be disposed on the base film 41 and welded to each of the positive electrode terminal 15d and the negative electrode terminal 15e. The bus bar 43 may be formed of copper, aluminum, or the like. The arrangement, structure, and specification of the bus bar 43 may also vary according to the capacity or size of the secondary battery module 30.

In addition, the FPCB 45 may be connected to the bus bar and may be fixed to the base film 41. The FPCB 45 may be fixed to the base film 41 in an adhesive manner (e.g., using an adhesive). The FPCB may serve to monitor and control the state of the secondary battery module 30 while communicating with the external BMS. The secondary battery module 30 according to some embodiments may have a smaller thickness by applying the FPCB that is thinner than a general PCB.

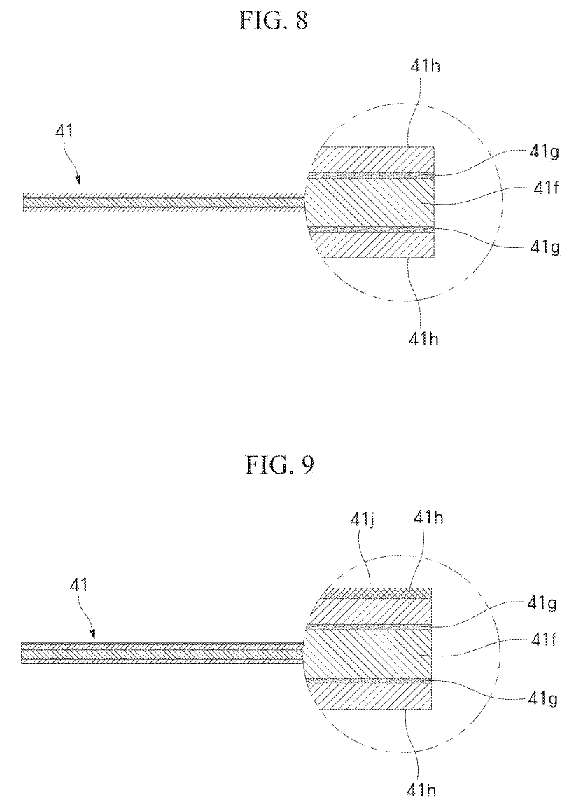

FIG. 8 is a view illustrating a stacked structure of the base film 41 illustrated in FIG. 7, according to some embodiments of the present disclosure.

As illustrated, the base film 41 may have a stacked structure including a core layer 41f and a cover layer 41h that have a set or predetermined thickness. The core layer 41f and the cover layer 41h may be bonded via the adhesive layer 41g to form a single body. The cover layer 41h may cover upper and lower surfaces of the core layer 41f.

The core layer 41f may include various suitable materials and may be, for example, a cycloolefin copolymer (COC) film. The COC film may have good electrical insulation due to high surface resistance, thereby improving (e.g., increasing) the reliability of the cell control unit. The electrical insulation may serve to ensure the electrical stability of the battery and prevent or substantially reduce damage due to an overcurrent condition.

In addition, the cover layer 41h may be formed of various suitable types of polymer materials. The cover layer 41h may have a smaller thickness than the core layer 41f and may serve to protect the core layer 41f. The cover layer 41h may be formed of polypropylene.

A combination of the COC film and the polypropylene film can increase the mechanical strength of the base film 41 and provide good insulation as a material for the cell control unit 40. In addition, the stacked structure can improve the overall performance of the secondary battery module 30 and also improve (e.g., increase) the thermal stability of the base film, thereby enabling a stable operation even in a high-temperature environment.

FIGS. 9 and 12 are cross-sectional views for describing various stack examples of the base film illustrated in FIG. 7, according to some embodiments of the present disclosure.

The base film 41 illustrated in FIG. 9 further includes an insulator 41j disposed on the cover layer 41h. The insulator 41j is an insulation film may have a set or predetermined thickness and may cover and support a part of the bus bar 43. The bus bar 43 may be covered by the insulator 41j. In some examples, the bus bar 43 is formed integrally with the base film 41 as one single unit.

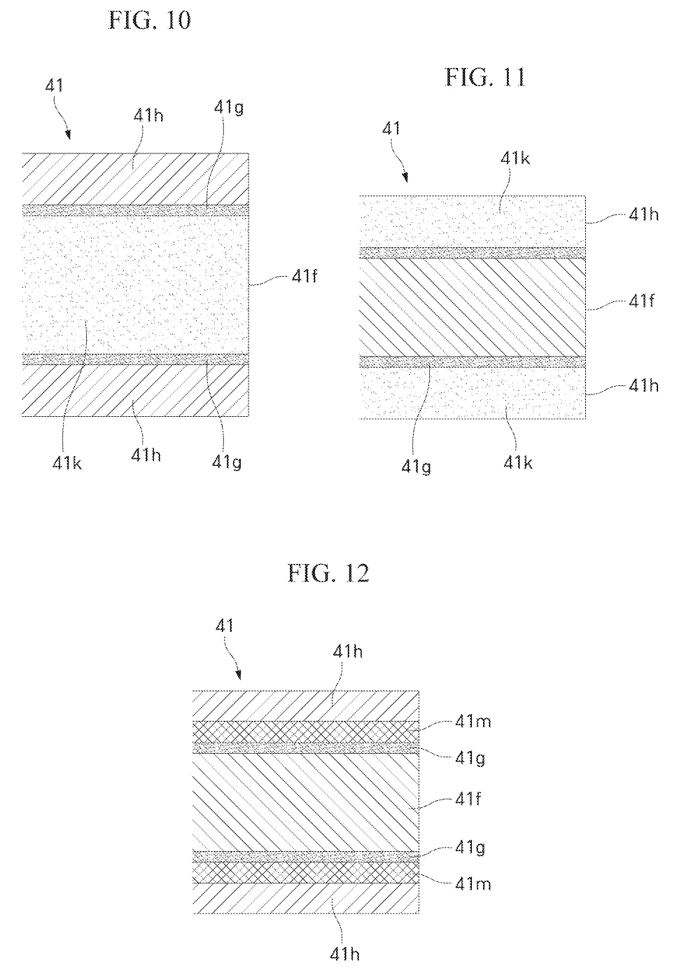

In addition, the base film 41 of FIG. 10 is a type in which inorganic nanoparticles 41k are dispersed in the core layer 41f. The inorganic nanoparticles may have high heat resistance and increase heat resistance in the base film 41. Accordingly, when the secondary battery module 30 heats up during normal operation, deformation or deterioration of the base film 41 due to high temperature can be prevented or substantially reduced.

The inorganic nanoparticles 41k may be applied to the cover layer 41h as illustrated in FIG. 11. That is, the inorganic nanoparticles 41k may be dispersed in the polymer forming the cover layer 41h.

Furthermore, the inorganic nanoparticles 41k may be applied to both the base film 41 and the cover layer 41h. In some examples, nanoclay or silicon dioxide may be used as the inorganic nanoparticles. The nanoclay or silicon dioxide can provide excellent mechanical properties and electrical insulation and thus improve the operational stability of the secondary battery module.

FIG. 12 is a view illustrating another example of the base film 41, according to some embodiments of the present disclosure.

As illustrated, the base film 41 further includes a reinforcing layer 41m applied between the core layer 41f and the cover layer 41h. The reinforcing layer 41m may serve to reinforce the structure of the base film 41 itself. The type of the reinforcing layer 41m that may serve such a role may be applied in any of various ways, and for example, the reinforcing layer 41m may be a fluororesin layer.

As is recognized by a person of ordinary skill in the art, fluororesin has excellent heat resistance and insulation performance and has good mechanical properties. By applying the reinforcing layer 41m, it is possible to reduce a damage occurrence rate even when an impact or vibration is applied to the base film 41. Because fluororesin has excellent heat resistance and chemical resistance, the fluororesin can stably respond to heat that may be generated from the battery cell. Furthermore, even when the secondary battery module 30 is overheated or a chemical reaction occurs, the base film 41 can be maintained well.

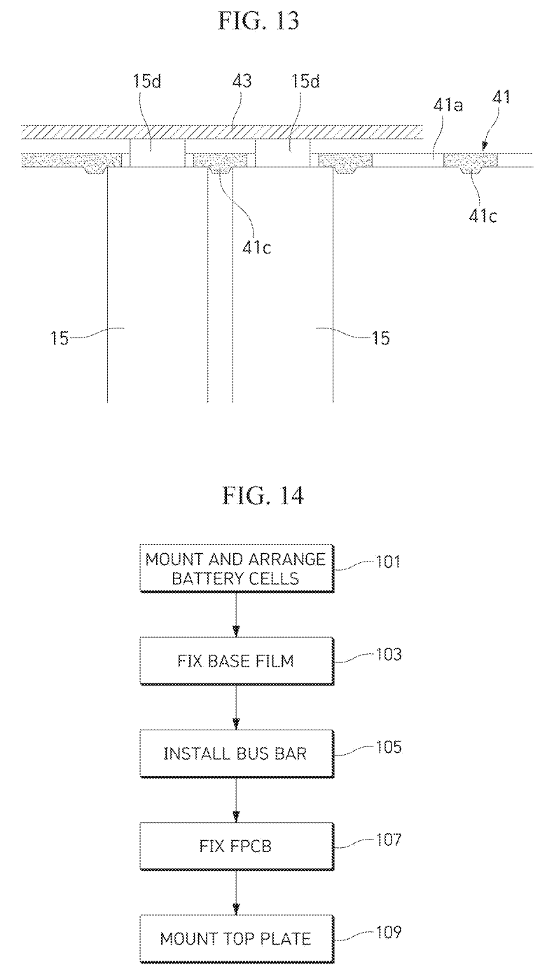

FIG. 13 is a cross-sectional view illustrating still another example of the base film 41 according to some embodiments of the present disclosure.

As illustrated, the base film 41 includes a support protrusion 41c that may be formed on the bottom surface of the base film 41. The support protrusion 41c is a portion that protrudes downward from the bottom surface of the base film 41. The support protrusion 41c may be inserted between neighboring battery cells 15 to suppress relative movement of the base film with respect to the battery cell 15.

In general, the battery cells 15 are disposed to be spaced a set or predetermined distance from each other due to a spacer (e.g., a gap) interposed (e.g., located) therebetween, and the support protrusion 41c is inserted between the battery cells 15. Because a constant or substantially constant interval between the neighboring battery cells 15 is maintained and a constant or substantially constant interval of the support protrusions 41c is also maintained, the base film 41 does not move relatively in a state in which the support protrusion 41c is inserted between the battery cells 15. That is, the base film 41 does not move in the arrangement direction of the battery cells 15 above the battery cells 15.

That is, the support protrusion 41c is a portion that protrudes downward from the bottom surface of the base film 41 and may play a structural role in increasing stability between the battery cells 15. The support protrusion 41c can reduce interference between the battery cells 15 and perform the function of evenly distributing a pressure of the base film affecting the battery cell. Such a structural arrangement ensures the physical stability of the battery cell, thereby preventing or substantially reducing the likelihood of deformation or damage even after long-term use.

In particular, the support protrusion 41c may be designed in any of various suitable shapes. For example, a height and width of the support protrusion 41c may be changed and adjusted according to various shapes of the battery. Such design diversity is an important factor in designing the secondary battery module 30 and may allow the secondary battery module 30 to exhibit optimal performance under various environmental conditions.

In addition, the support protrusion 41c can not only reduce interference between neighboring battery cells 15 but also protect the battery cell 15 from an external impact or vibration. Thus, the impact resistance of the battery cells may be increased.

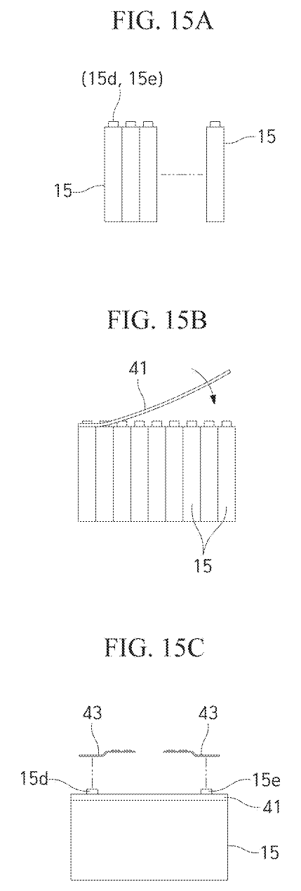

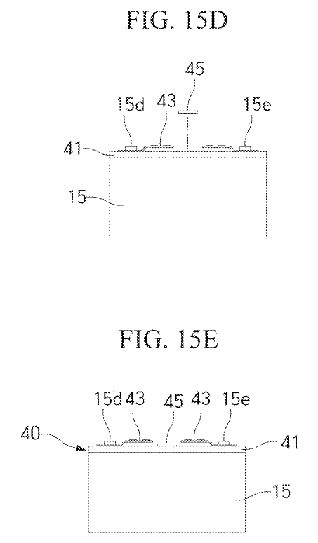

FIG. 14 is a flowchart illustrating a method of manufacturing a secondary battery module according to some embodiments of the present disclosure, and FIGS. 15A-15E are schematic views illustrating the method of manufacturing a secondary battery module according to some embodiments of the present disclosure.

As illustrated, the method for manufacturing a secondary battery module according to some embodiments may include a battery cell mounting operation 101, a base film fixing operation 103, a bus bar installing operation 105, an FPCB fixing operation 107, and a top plate mounting operation 109.

The battery cell mounting operation 101 is a process of mounting the battery cells 15 parallel to each other inside the case main body 31a. The battery cells 15 may be in close contact with each other while spaced a set or predetermined interval from each other due to a spacer interposed therebetween. In addition, as illustrated in FIG. 15A, the positive electrode terminal 15d, the negative electrode terminal 15e, and the vent hole 15g may be located on the upper portion of the battery cell 15.

Next, the base film fixing operation 103 is a process of fixing the base film 41 on the plurality of battery cells 15 fixed inside the case main body 31a through the battery cell mounting operation 101. As described above, as illustrated in FIG. 7, the base film 41 may have a plurality of terminal passages 41a and vent hole corresponding holes 41b, and the positive electrode terminal 15d and the negative electrode terminal 15e may be inserted into the terminal passages 41a. FIG. 15B schematically illustrates the base film 41 applied to the upper portion of the battery cells 15 coupled in close contact with each other.

The positive electrode terminal 15d and the negative electrode terminal 15e may protrude upward from the base film 41 through the terminal passages 41a. In addition, the vent hole corresponding hole 41b opens the vent hole 15g upward.

The base film fixing operation 103 is a process of adhesively fixing (i.e., fixing via an adhesive) the base film 41 to the upper surface of the battery cell 15. In addition, when the support protrusion 41c is formed on the bottom surface of the base film 41, the support protrusion 41c may be inserted into a gap between the battery cells 15.

Next, the bus bar installing operation 105 may be a process of arranging the bus bar 43 on the base film 41 and electrically connecting the bus bar 43 to each of the positive electrode terminal 15d and the negative electrode terminal 15e. The bus bar may be coupled to the positive electrode terminal 15d and the negative electrode terminal 15e by welding (see, e.g., FIG. 15C).

In addition, as illustrated in FIG. 15D, the FPCB fixing operation 107 is a process of fixing the FPCB 45 to the upper surface of the base film 41. During the FPCB fixing operation 107, the FPCB 45 may be connected to the bus bar 43.

In such examples, the FPCB 45 may be fixed to the base film 41 in an adhesive manner. That is, the FPCB 45 is fixed using an adhesive. The cell control unit 40 may be configured by fixing the bus bar 43 and the FPCB 45 to the base film 41. FIG. 15E illustrates a state in which the bus bar 43 and the FPCB 45 are applied on the base film 41 so that the cell control unit 40 is formed on the upper surface of the battery cell 15.

The top plate mounting operation 109 is a process of covering the case main body 31a with the top plate 31b to seal the case main body 31a. In such examples, the battery cell 15 and the cell control unit 40 are accommodated inside the case main body 31a.

According to a secondary battery module of the present disclosure, because a CCU having a relatively small thickness compared to a CCU of the related art formed of plastic is provided, it is possible to achieve excellent space efficiency of the module and increase a volume rate and capacity of the secondary battery module.

Although the present disclosure has been described above with respect to embodiments thereof, the present disclosure is not limited thereto. Various suitable modifications and variations can be made thereto by those skilled in the art within the spirit of the present disclosure as defined by the appended claims and their equivalents.

What is claimed is:

1. A secondary battery module comprising:
a plurality of battery cells each of which has a positive electrode terminal and a negative electrode terminal;
a cell control unit configured to control the battery cells; and
a module case configured to accommodate the battery cells and the cell control unit,
wherein the cell control unit comprises:
a base film;
bus bars on the base film and connected to the positive electrode terminal and the negative electrode terminal; and
a flexible printed circuit board (FPCB) connected to the bus bars and fixed to the base film.

2. The secondary battery module as claimed in claim 1, wherein the base film has a stacked structure comprising a core layer and cover layers covering an upper surface and a bottom surface of the core layer.

3. The secondary battery module as claimed in claim 2, wherein the core layer is a cycloolefin copolymer (COC) film.

4. The secondary battery module as claimed in claim 3, wherein each of the cover layers is a film formed of a polymer material.

5. The secondary battery module as claimed in claim 2, wherein the base film further comprises an insulator covering a part of the bus bars and is mounted on a cover layer of the cover layers of the base film.

6. The secondary battery module as claimed in claim 2, wherein the core layer comprises inorganic nanoparticles.

7. The secondary battery module as claimed in claim 2, wherein the cover layers comprise inorganic nanoparticles.

8. The secondary battery module as claimed in claim 1, wherein the base film comprises a support protrusion formed on a bottom surface of the base film, and
wherein the support protrusion is inserted between neighboring battery cells to suppress relative movement of the base film with respect to the battery cells.

9. The secondary battery module as claimed in claim 2, wherein the base film comprises a reinforcing layer formed to reinforce a structure of the base film and is provided between the core layer and a cover layer of the cover layers.

10. A film-type cell control unit for a secondary battery module, comprising:
a base film configured to provide a support force to a plurality of battery cells each of which has a positive electrode terminal and a negative electrode terminal;
bus bars on the base film and connected to the positive electrode terminal and the negative electrode terminal; and
a flexible printed circuit board (FPCB) connected to the bus bars and fixed to an upper surface of the base film.

11. The film-type cell control unit as claimed in claim 10, wherein the base film has a stacked structure comprising a core layer and cover layers covering an upper surface and a bottom surface of the core layer.

12. The film-type cell control unit as claimed in claim 11, wherein the core layer is a cycloolefin copolymer (COC) film.

13. The film-type cell control unit as claimed in claim 12, wherein each of the cover layers is a film formed of a polymer material.

14. The film-type cell control unit as claimed in claim 11, wherein the base film further comprises an insulator covering a part of the bus bars and is mounted on a cover layer of the cover layer of the base film.

15. The film-type cell control unit as claimed in claim 11, wherein the core layer comprises inorganic nanoparticles.

16. The film-type cell control unit as claimed in claim 11, wherein the cover layers comprise inorganic nanoparticles.

17. The film-type cell control unit as claimed in claim 10, wherein the base film comprises a support protrusion formed on a bottom surface of the base film, and
wherein the support protrusion is inserted between neighboring battery cells to suppress relative movement of the base film with respect to the battery cells.

18. The film-type cell control unit as claimed in claim 11, wherein the base film comprises a reinforcing layer formed to reinforce a structure of the base film and is provided between the core layer and a cover layer of the cover layers.

19. A method of manufacturing a secondary battery module, comprising:
a battery cell mounting operation of mounting a plurality of battery cells each having a positive electrode terminal and a negative electrode terminal in a case main body;
a base film fixing operation of fixing a base film to the battery cell;
a bus bar installing operation of arranging bus bars on the base film and connecting the bus bars to the positive electrode terminal and the negative electrode terminal;
a flexible printed circuit board (FPCB) fixing operation of fixing an FPCB to the base film and connecting the FPCB to the bus bars; and
a top plate mounting operation of covering the case main body with a top plate to seal the case main body.

20. The method as claimed in claim 19, wherein the base film fixing operation is a process of adhering the base film to the battery cells, and
wherein the FPCB fixing operation is a process of adhesively coupling the FPCB to an upper surface of the base film.
